(19) United States
(12) Patent Application Publication
(10) Pub. No.: US 2024/0300580 A1
(43) Pub. Date: Sep. 12, 2024

(54) FRONT SUBFRAME STRUCTURE

(71) Applicant: HONDA MOTOR CO., LTD., Tokyo (JP)

(72) Inventors: Seiji HAYAKAWA, Wako-shi, Saitama (JP); Tomomi SASAKI, Wako-shi, Saitama (JP); Takehiko KOSHIISHI, Wako-shi, Saitama (JP); Tomoo WATANABE, Wako-shi, Saitama (JP)

(21) Appl. No.: 17/279,166

(22) PCT Filed: Sep. 27, 2018
(86) PCT No.: PCT/JP2018/036153

§ 371 Date: Mar. 24, 2021

(51) Int. Cl. B62D 21/11; B62D 21/02

(52) U.S. Cl. CPC B62D 21/11; B62D 21/02

(57) ABSTRACT

A front subframe structure includes: a pair of right and left longitudinal members extending substantially in a longitudinal direction of a vehicle; a cross member extending in a width direction of the vehicle between the pair of right and left longitudinal members; and a pair of right and left load receiving portions arranged on a vehicle body floor at a distance in the width direction. A rear end of each of the pair of longitudinal members is arranged to overlap in the longitudinal direction with each of the pair of load receiving portions, and the rear end of each of the pair of longitudinal members has a dimension (W5) in the width direction which is made larger than a dimension (W4) in the width direction of a base of each of the pair of longitudinal members (W5>W4).

### TECHNICAL FIELD

The present invention relates to a front subframe structure arranged at a front of a vehicle.

### BACKGROUND ART

For example, Patent Document 1 discloses a structure in which, at the time of a frontal collision, a deformation mode of a front side frame is controlled to drop a front subframe below a vehicle body floor.

In other words, Patent Document 1 discloses the structure in which, at the time of a frontal collision, a rear end of the front subframe drops downward, while contacting and sliding along a slide slope of a lower dashboard.

### CITATION LIST

Patent Document 1: Japanese Patent No. 5460684

### SUMMARY OF THE INVENTION

### Problems to be Solved

Meanwhile, a so-called offset collision may occur, in which a vehicle collides on a front portion thereof at a position offset either right or left with respect to the center in a width direction, for example.

In the case of the offset collision, the rear end of the front subframe may be displaced in the width direction so that the rear end of the front subframe fails to contact and slide along the slide slope.

The present invention has been made in view of the above problem and provides a front subframe structure in which a front subframe reliably drops even when an offset collision load is inputted.

### Solution to Problem

To solve the problem described above, the present invention provides a front subframe structure including: a pair of right and left longitudinal members extending substantially in a longitudinal direction of a vehicle; and a cross member extending in a width direction of the vehicle between the pair of right and left longitudinal members, and the structure further includes a pair of right and left load receiving portions arranged on a vehicle body floor at a distance in the width direction, wherein a rear end of each of the pair of longitudinal members is arranged to overlap in the longitudinal direction with each of the pair of load receiving portions, and the rear end of each of the pair of longitudinal members has a dimension (W5) in the width direction which is made larger than a dimension (W4) in the width direction of a base of each of the pair of longitudinal members.

### Advantageous Effects of the Invention

The present invention provides a front subframe structure in which a front subframe reliably drops even when an offset collision load is inputted.

### BRIEF DESCRIPTION OF THE DRAWINGS

FIG. 1 is a perspective view of a front portion of a vehicle assembled with a front subframe according to an embodiment of the present invention, as viewed from obliquely above;

FIG. 2 is a bottom view of the front subframe in FIG. 1;

FIG. 3 is a side view as viewed from a direction of an arrow X in FIG. 2;

FIG. 4 is a cross-sectional view taken along a line IV-IV in FIG. 3;

FIG. 5 is a cross-sectional perspective view taken along the line IV-IV in FIG. 3; and

FIG. 6 is a diagram illustrating a deformation mode of the front subframe at the time of an offset collision.

### EMBODIMENTS OF THE INVENTION

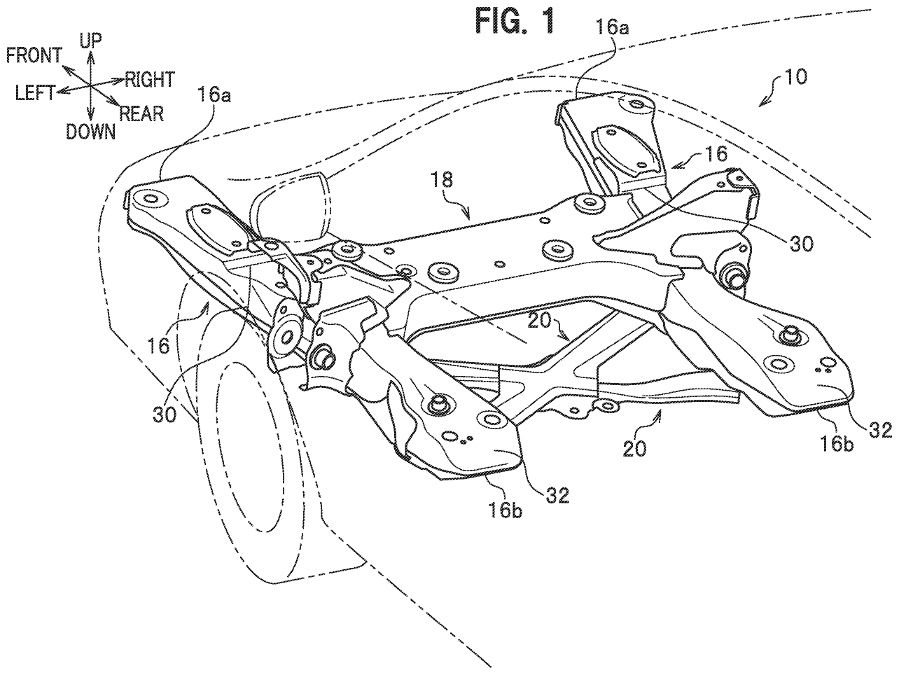

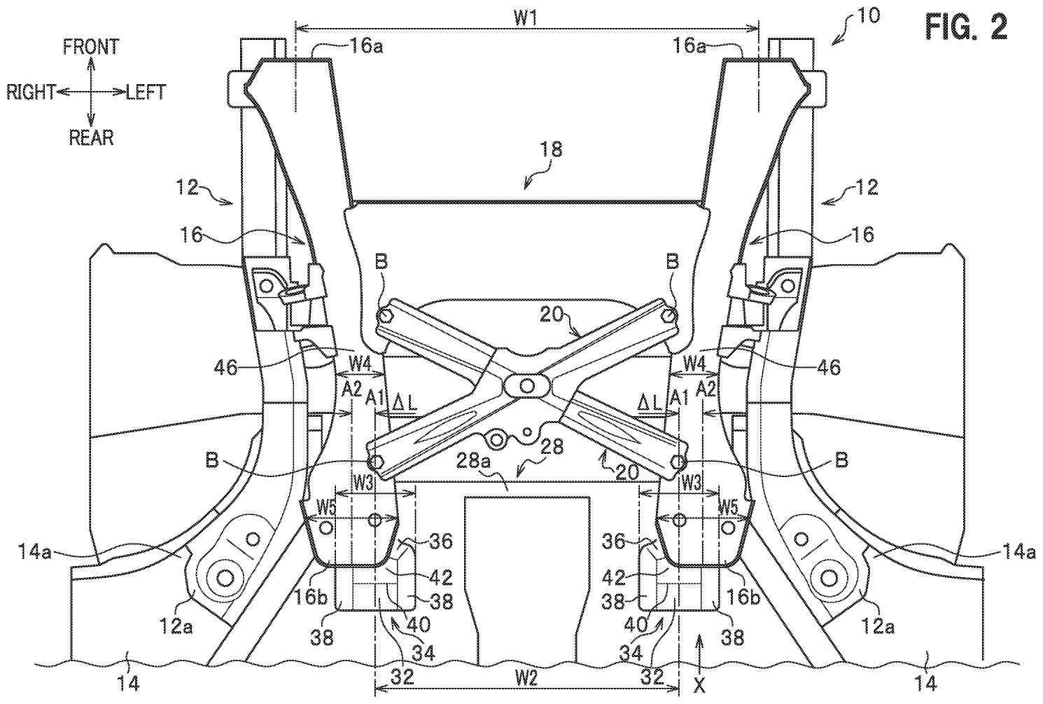

Next, a description is given of an embodiment of the present invention in detail with reference to the drawings as appropriate. FIG. 1 is a perspective view of a front portion of a vehicle assembled with a front subframe according to the embodiment of the present invention, as viewed from obliquely above, and FIG. 2 is a bottom view of the front subframe in FIG. 1. Note that, in each drawing, “front-rear” indicates a longitudinal direction of a vehicle, “right-left” indicates a width direction (right-left direction) of the vehicle, and “up-down” indicates a vertical direction of the vehicle.

As illustrated in FIG. 1, a front subframe 10 according to the embodiment of the present invention is arranged in the front portion of the vehicle. The front subframe 10 is mounted under a pair of right and left front side frames 12 (see FIG. 2) extending in the longitudinal direction. Further, the front subframe 10 supports a suspension device for front wheels (not illustrated) and a power unit (a drive source such as a motor and an engine) via a mount mechanism (not illustrated).

Note that rear ends 12a of the pair of right and left front side frames 12 are coupled to front ends 14a of right and left outriggers 14 (see FIG. 2).

As illustrated in FIG. 1, the front subframe 10 includes a pair of right and left longitudinal members 16, a cross member 18, and a pair of braces 20.

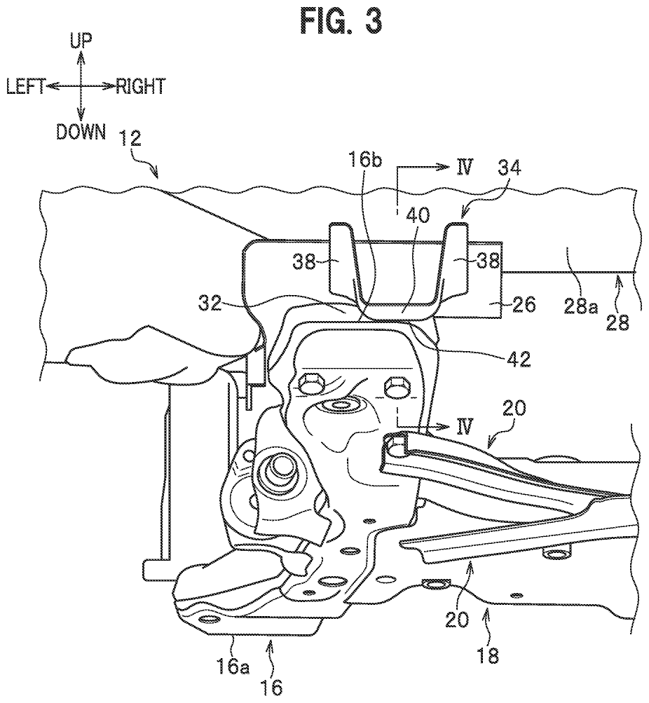

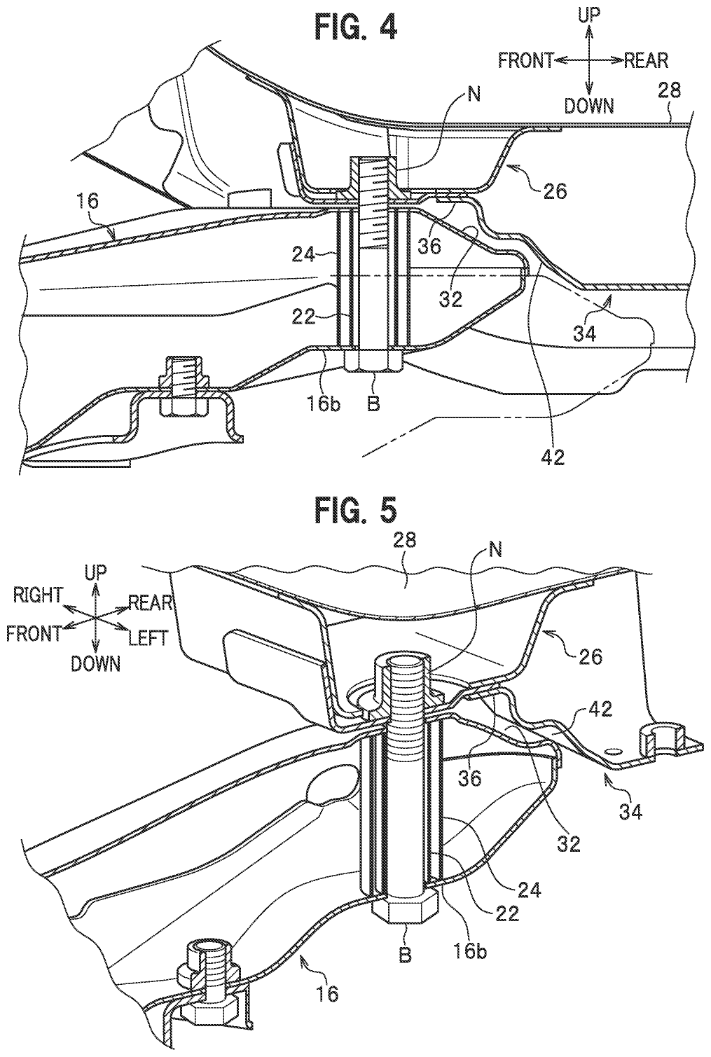

FIG. 3 is a side view as viewed from a direction of an arrow X in FIG. 2, FIG. 4 is a cross-sectional view taken along a line IV-IV in FIG. 3, and FIG. 5 is a cross-sectional perspective view taken along the line IV-IV in FIG. 3.

As illustrated in FIG. 2, the pair of right and left longitudinal members 16 extend substantially in the longitudinal direction. A front end of each longitudinal member 16 is coupled to the front side frame 12 via a coupling frame (not illustrated) extending upward. As illustrated in FIGS. 4 and 5, a rear end 16b of each longitudinal member 16 is fixed to a fixing bracket 26 by a bolt B penetrating a first collar member 22 and a second collar member 24, which respectively have different outer diameters from each other, and a nut N.

As illustrated in FIGS. 4 and 5, the first collar member 22 and second collar member 24 are coaxially arranged in a closed cross section of the longitudinal member 16. The fixing brackets 26 are arranged on both the right and left sides, respectively, at a predetermined distance in the width direction. The fixing brackets 26 are joined to a bottom surface of a floor panel (vehicle body floor) 28 to be described below.

As illustrated in FIG. 2, the cross member 18 extends in the width direction between central portions of the pair of right and left longitudinal members 16. The pair of braces 20 are arranged behind the cross member 18 and are fastened diagonally by the bolts B to couple the pair of right and left longitudinal members 16.

As illustrated in FIG. 2, the front subframe 10 has a substantially H-shape in a plan view formed by the pair of right and left longitudinal members 16 and the cross member 18. Further, a front end 16a of each longitudinal member 16 is positioned outward in the width direction with respect to a rear end 16b of each longitudinal member 16 to have a forward increase in distance between the two members. That is, a distance (W1) in the width direction between the front ends 16a of the pair of right and left longitudinal members 16 is larger than a distance (W2) in the width direction between the rear ends 16b (W1>W2).

As illustrated in FIG. 1, each longitudinal member 16 has a bent (weak) portion 30 to cause the longitudinal member 16 to be deformed downward starting with the central portion of the longitudinal member 16 when an offset load is inputted. The bent portion 30 is formed of a stepped portion located in front of a coupled portion where the cross member 18 is coupled to each longitudinal member 16. The stepped portion extends in a direction (width direction) orthogonal to an axis of the longitudinal member 16 in a plan view.

Further, as illustrated in FIGS. 4 and 5, the rear end 16b of each longitudinal member 16 has an inclined surface 32 which inclines downward from the front toward the rear of the vehicle.

As illustrated in FIG. 2, the floor panel (vehicle body floor) 28 is arranged between the front ends 14a of the right and left outriggers 14 in the width direction. The fixing brackets 26 are fixed to a front end 28a on the bottom surface of the floor panel 28. A pair of right and left load receiving portions 34 having a predetermined distance therebetween in the width direction are each fixed to a rear of the pair of right and left fixing brackets 26.

The pair of right and left load receiving portions 34 are formed in the same shape. As illustrated in FIGS. 2 and 3, each load receiving portion 34 has a front end flange 36, right and left flanges 38, and a bulged portion 40. When the load receiving portion 34 is viewed from the bottom, the front end flange 36 is continuous to the right and left flanges 38 to form a flange having a U-shape.

The front end flange 36 is located at the front end of the floor panel 28 to be joined to a bottom surface of the fixing bracket. The right and left flanges 38 extend rearward from the front end flange 36 on both the right and left sides of the front end flange 36. The bulged portion 40 forms a closed cross section inside and is continuous to the front end flange 36 and the right and left flanges 38 to bulge downward.

An inclined surface 42 is arranged on a front side of the bulged portion 40 facing the rear end 16b of each longitudinal member 16. The inclined surface 42 is formed to incline downward from the front toward the rear. The inclined surface 42 is arranged to face the inclined surface 32 of the rear end 16b of the longitudinal member 16 in the longitudinal direction (see FIG. 4).

As illustrated in FIG. 2, the rear end 16b of each longitudinal member 16 is arranged to overlap each load receiving portion 34 in the longitudinal direction. Further, a dimension (W5) in the width direction of the rear end 16b itself of each longitudinal member 16 is larger than a dimension (W4) in the width direction of a base 46 of each longitudinal member 16 (W5>W4). Still further, the dimension (W5) in the width direction of the rear end 16b itself of each longitudinal member 16 is larger than a dimension (W3) in the width direction of each load receiving portion 34 (W5>W3). Furthermore, an axis (A1) passing through the center of each load receiving portion 34 is offset toward the center (inner side in the width direction) by a distance ΔL in the width direction, with respect to an axis (A2) passing through the center of the rear end 16b of each longitudinal member 16.

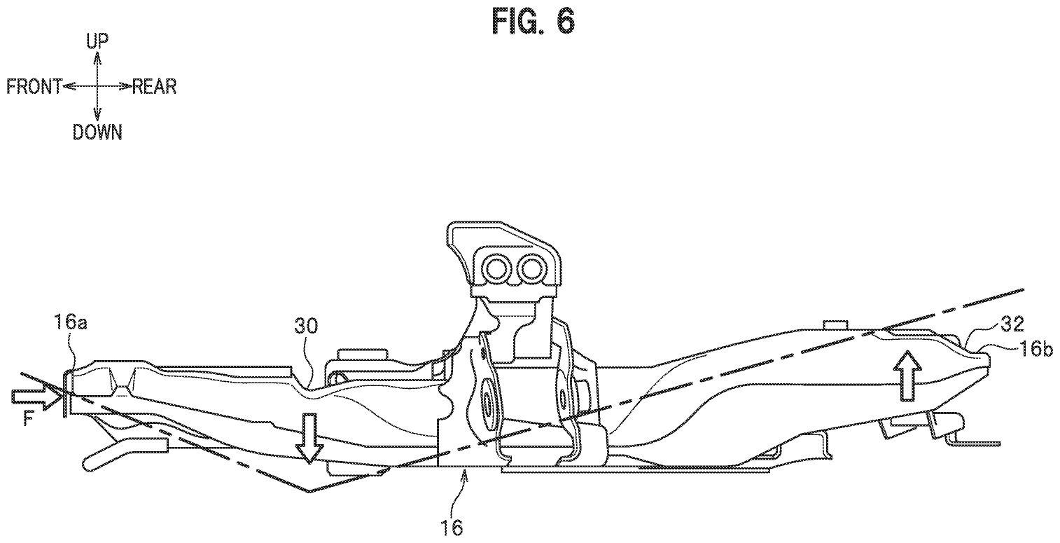

The front subframe structure according to the present embodiment is basically formed as described above. Next, a description is given of advantageous effects thereof. FIG. 6 is a diagram illustrating a deformation mode of the front subframe at the time of an offset collision.

First, a description is given of a case where an offset collision load is inputted to the front subframe 10 (either the right or left longitudinal member 16) at the time of an offset collision.

At the time of an offset collision, an offset collision load (F) is inputted to the longitudinal member 16 of the front subframe 10 via the front side frame 12. As illustrated in FIG. 6, the longitudinal member 16 is bent downward (direction as indicated by an arrow) substantially in a dogleg shape, starting with the bent portion 30 as a stepped portion, due to the offset collision load (F) inputted to the longitudinal member 16. This generates upward stress (see an arrow) on the rear end 16b of the longitudinal member 16 which has been deformed so as to be bent downward. Based on the principle of leverage, the bolt B, which has been fastening the rear end 16b of the longitudinal member 16 to the front side frame 12, drops off. This causes the rear end 16b of the longitudinal member 16 to be free, and the inclined surface 32 of the rear end 16b of the longitudinal member 16 is displaced rearward and downward, while contacting and sliding along the inclined surface 42 of the load receiving portion 34. As a result, in the present embodiment, even when the offset collision load (F) is inputted to the front subframe 10, the front subframe 10 suitably drops rearward and downward.

In the present embodiment, the rear end 16b of each longitudinal member 16 is arranged to overlap each load receiving portion 34 in the longitudinal direction, and the dimension (W5) in the width direction of the rear end 16b itself of each longitudinal member 16 is made larger than the dimension (W4) in the width direction of the base 46 of each longitudinal member 16 (W5>W4). In the present embodiment, for example, even when the offset collision load (F) is inputted and the rear end 16b of the longitudinal member 16 is moved rearward while being displaced in the width direction, the rear end 16b of the longitudinal member 16 is reliably brought in contact with the load receiving portion 34 arranged on the floor panel 28. Thus, in the present embodiment, the front subframe 10 is slid toward a position under the floor panel 28 so that the deformation of the floor panel 28 is prevented.

Particularly, in a case where a motor (not shown) is mounted as a power unit and a battery (not shown) is mounted on the floor panel 28, for example, even when the offset collision load (F) is inputted and the front subframe 10 is slid rearward and downward, the front subframe 10 is suitably prevented from contacting or abutting the battery.

Further, in the present embodiment, the dimension (W5) in the width direction of the rear end 16b of each longitudinal member 16 is made larger than the dimension (W3) in the width direction of each load receiving portion 34 (W5>W3). In the present embodiment, this allows the rear end 16b of the longitudinal member 16 of the front subframe 10 to be reliably brought in contact with the load receiving portion 34.

Still further, in the present embodiment, the axis (A1) of each load receiving portion 34 passes through a position offset toward the center in the width direction (inner side) by the distance ΔL, with respect to the axis (A2) of the rear end 16b of each longitudinal member 16. For example, when the vehicle has an offset collision, the longitudinal member 16 on a side, where the offset collision load (F) is inputted, is moved rearward and downward of the vehicle while being displaced toward the center in the width direction. Meanwhile, in the present embodiment, the load receiving portion 34 is positioned closer to the center in the width direction by the distance ΔL than the rear end 16b of the longitudinal member 16 in advance, so that the rear end 16b of the front subframe 10 is reliably brought in contact with the load receiving portion 34.

Yet further, in the present embodiment, the front end 16a of each longitudinal member 16 is arranged outward in the width direction with respect to the rear end 16b to have a forward increase in distance between the two members. In the present embodiment, the front end 16a of the longitudinal member 16 is arranged outward in the width direction with respect to the rear end 16b in advance, so that the offset collision load (F) is widely received by the front end 16a of the longitudinal member 16.

Furthermore, in the present embodiment, the rear end 16b of each longitudinal member 16 is located at a position closer to the center in the width direction with respect to the front end 16a, so that, when the vehicle has an offset collision, the rear end 16b of the longitudinal member 16 is more reliably brought in contact with the load receiving portion 34 which is offset toward the center.

### REFERENCE NUMERALS

10: front subframe; 16: longitudinal member; 16a: front end (of longitudinal member); 16b: rear end (of longitudinal member); 18: cross member; 28: floor panel (vehicle body floor); 34: load receiving portion; 42: inclined surface; 46: base; A1: axis of load receiving portion; A2: axis of rear end of longitudinal member.

What is claimed is:

1. A front subframe structure comprising:
a pair of right and left longitudinal members extending substantially in a longitudinal direction of a vehicle; and
a cross member extending in a width direction of the vehicle between the pair of right and left longitudinal members, and
the structure further comprises:
a pair of right and left load receiving portions arranged on a vehicle body floor at a distance in the width direction,
wherein a rear end of each of the pair of longitudinal members is arranged to overlap in the longitudinal direction with each of the pair of load receiving portions, and
the rear end of each of the pair of longitudinal members has a dimension (W5) in the width direction which is made larger than a dimension (W4) in the width direction of a base of each of the pair of longitudinal members (W5>W4).

2. The front subframe structure as claimed in claim 1,
wherein the dimension (W5) in the width direction of the rear end of each of the pair of longitudinal members is made larger than a dimension (W3) in the width direction of each of the pair of load receiving portions (W5>W3).

3. The front subframe structure as claimed in claim 1 or 2,
wherein an axis (A1) of each of the pair of load receiving portions passes through a position offset toward a center in the width direction with respect to an axis (A2) of the rear end of each of the pair of longitudinal members.

4. The front subframe structure as claimed in claim 3,
wherein a front end of each of the pair of longitudinal members is arranged outward in the width direction with respect to the rear end to have a forward increase in distance between the two members.
